(19) United States
(12) Patent Application Publication
(10) Pub. No.: US 2023/0137392 A1
(43) Pub. Date: May 4, 2023

(54) MANICURE PRACTICE HAND MODEL

(71) Applicant: Guiwen CAI, Guangzhou (CN)

(72) Inventor: Guiwen CAI, Guangzhou (CN)

(21) Appl. No.: 17/513,906

(22) Filed: Oct. 29, 2021

(51) Int. Cl. G09B 19/10

(52) U.S. Cl. CPC G09B 19/10

(57) ABSTRACT

The present invention provides a manicure practice hand model. Simulated fingernails are provided on fingernail beds at free ends of fingertips on a back side of simulated fingers; fingernail mounting grooves are provided on the fingernail beds at the free ends of the fingertips on the back side of the simulated fingers; a fingernail fixing member is provided on an inner surface of each of the simulated fingernails, and the fingernail fixing member has a shape and size matching with those of the fingernail mounting groove. The present invention achieves the flexible disassembly of the simulated fingernails and the simulated fingers, has advantages of convenient mounting and stable fixation, and is suitable for multiple times of extraction and replacement.

### FIELD OF TECHNOLOGY

The present invention relates to the field of manicure, in particular to a manicure practice hand model for manicure.

### BACKGROUND

Manicure is a process for decorating and beautifying fingernails, also referred to as a fingernail art design. Manicurists can create different ideas on the fingernails of customers. Many novice manicurists need many attempts and training to become qualified manicurists. When manicurists innovate and create, they need to try many times before recommending and implementing manicure to customers. At present, there are many nail training fingernail pieces on the market. The fingernail pieces are mounted on a base for the practitioner to use, but individual nails cannot well show the overall manicure effect of the hand. For some manicure practice hand models, some fingernail pieces are inserted on the hand model. After pulling and inserting for many times, the connection will be loose, and the training effect will be affected.

### SUMMARY

An objective of the present invention is to provide a manicure practice hand model, thereby achieving the flexible disassembly of fingernail pieces and a hand model, having the convenient mounting and stable fixation, and being suitable for multiple extraction and replacement.

In order to achieve the above object, the present invention provides the following technical solutions:

A manicure practice hand model, comprising a practice hand model, wherein the practice hand model comprises a simulated palm and several simulated fingers mounted at a front end of the simulated palm, and simulated fingernails are provided on fingernail beds at free ends of fingertips on a back side of the several simulated fingers; nail mounting grooves are provided on the fingernail beds of the free ends of the fingertips on the back side of the simulated fingers; the fingernail mounting grooves are each provided along a fingertip end toward the root of the finger, and each simulated fingernail comprises an outer fingernail surface used for manicure and an inner fingernail surface, the inner fingernail surface is provided with a fingernail fixing member, and the fingernail fixing member has a shape and size matching with those of the fingernail mounting grooves.

Further, the fingernail fixing member is an “I”-shaped uniform elongated block having a wide upper and lower end face and a narrow middle portion, and the fingernail mounting groove is an inverted T structure groove having an inverted “T”-shaped cross section.

Further, a mortise and tenon structure is formed by the fingernail fixing member and the inverted T structure groove.

Further, an open notch at the fingertip end is provided on the inverted T structure groove. Further, the fingernail fixing member further comprises a fixing member attachment body, and an attachment surface of the fixing member attachment body is fixedly bonded to the inner fingernail surface.

Further, the attachment surface of the fixing member attachment body has a width greater than the width in the groove of the inverted T structure groove.

Further, the inner fingernail surface comprises a fingernail center line taking a direction where the fingernails point as a longitudinal direction, and the simulated fingernail is symmetrical with respect to the fingernail center line.

Further, when the fixing member attachment body is bonded to the inner fingernail surface, the longitudinal center line of the fixing member attachment body coincides with the fingernail center line of the inner fingernail surface.

Further, each simulated fingernail comprises a fingernail rear half portion mounted on the simulated finger and a fingernail front half portion extending out of the fingertip end, and the fixing member attachment body is bonded to the fingernail rear half portion of the inner fingernail surface.

Further, the overall shape of the simulated fingernail is a curved surface in which the outer fingernail surface is curved toward the inner fingernail surface.

It can be determined from analysis that the present invention discloses a manicure practice hand model, which simulates the shape of a human hand, has simulated palms and simulated fingers, also has a simulated fingernail capable of being flexibly disassembled, has the fixation between the simulated fingernail and simulated fingertip ends by using a T-shaped structure fingernail fixing member and an inverted T shaped structure groove to be connected in an interference fit, thereby having a firmly mounting, being suitable for multiple extraction and replacement, and being convenient for manicurists to perform multiple simulation training on the fingernail. The present invention has the simple mounting and replacement operations, and can meet multiple replacements without affecting the security of mounting and use, thereby being more economical and durable for a user and a trainer.

The technical solution of the present invention reduces the operation difficulty of mounting and disassembly, greatly reduces the replacement time and working intensity of the fingernail, and saves costs.

### BRIEF DESCRIPTION OF THE DRAWINGS

The accompanying drawings constituting a part of the present application are used for providing a further understanding of the present invention. The schematic embodiments and descriptions of the present invention are used for explaining the present invention, and do not constitute an improper limitation of the present invention, in which:

FIG. 1 is a structural schematic diagram of a manicure practice hand model of the present invention;

FIG. 2 is a structural schematic diagram of a manicure practice hand model before mounting a simulated fingernail according to the present invention;

FIG. 3 is a schematic diagram of the fingertip structure of a manicure practice hand model before mounting the simulated nail according to the present invention;

FIG. 4 is a schematic diagram of the structure of one shaft side of the simulated fingernail of the manicure practice hand model according to the present invention;

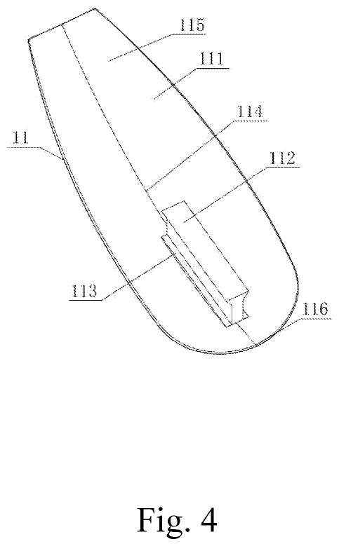

FIG. 5 is a schematic diagram of the structure of one shaft side of the simulated fingernail of the manicure practice hand model according to the present invention; and

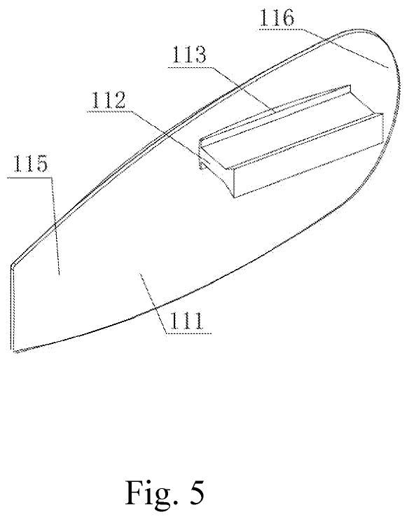

FIG. 6 is a side view of a simulated fingernail of the manicure practice hand model according to the present invention.

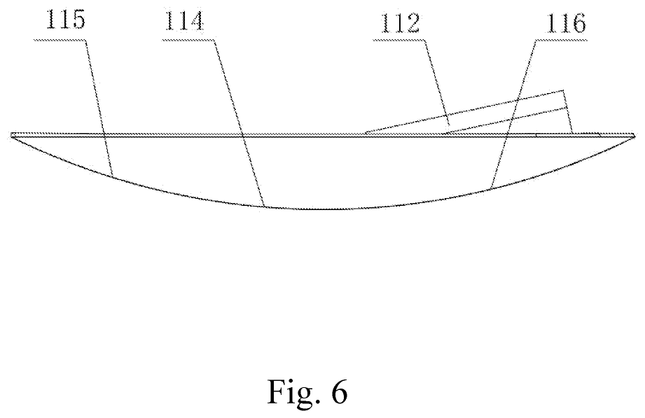

### DESCRIPTION OF REFERENCE NUMERALS

1—practice hand model; 11—simulated fingernail; 12—simulating a finger. 110—outer fingernail surface; 111—inner fingernail surface; 112—fingernail fixing member; 113—fixing member attachment body, 114—fingernail center line; 115—fingernail front half portion; 116—fingernail rear half portion; 121—fingernail mounting groove; 122—inverted T structure groove; and 123—fingertip end.

### DESCRIPTION OF THE EMBODIMENTS

The present disclosure will be described below with reference to the drawings and embodiments in detail. The respective examples are provided by way of explanation of the present invention without limiting the present invention. Indeed, it will be apparent to those skilled in the art that modifications and variations can be made in the present invention without departing from the scope or spirit of the invention. For example, features illustrated or described as being part of one embodiment may be used in another embodiment to yield yet another embodiment. Therefore, it is expected that the present invention includes such modifications and variations that fall within the scope of the claims and their equivalents.

In the description of the present invention, orientation or position relationships indicated by terms such as “longitudinal”, “lateral”, “up”, “down”, “front”, “rear”, “left”, “right”, “vertical”, “horizontal”, “top”, and “bottom” are based on orientation or position relationships shown in the accompanying drawings, which are only used for facilitating description of the present invention rather than requiring that the present invention must be constructed and operated in a specific orientation, and therefore cannot be construed as a limitation on the present invention. The terms “connected”, “connecting” and “provided” used in the present invention should be understood broadly, for example, may be fixed connections or detachable connections; may be direct connections or indirect connections by means of intermediate components; may be wired connections or radio connections; and may also be wireless communication signal connections. For a person of ordinary skill in the art, the specific meaning of the terms may be understood according to specific situations.

One or more examples of the invention are illustrated in the accompanying drawings. The detailed description uses numerals and letter designations to refer to features in the drawings. Similar or analogous labels in the drawings and descriptions have been used for referring to similar or analogous parts of the present invention. As used herein, the terms “first”, “second”, and “third” are used interchangeably for distinguishing one member from another, and are not intended to represent the location or importance of the individual members.

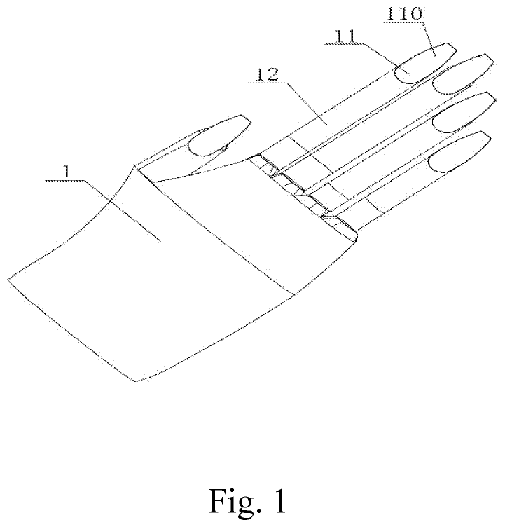

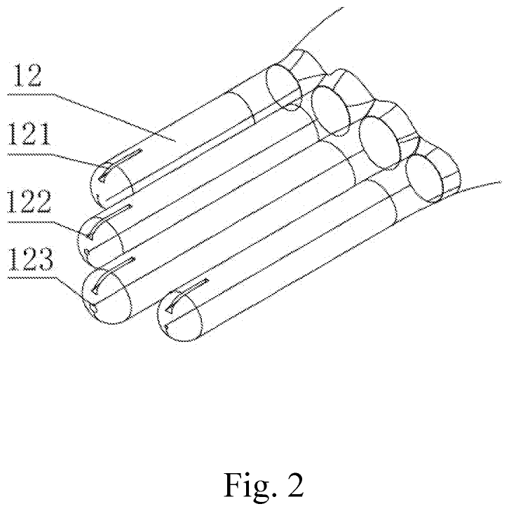

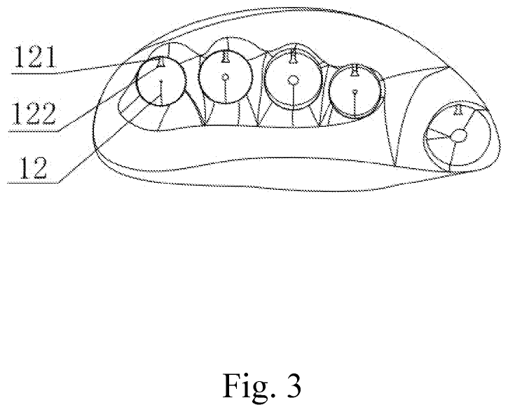

As shown in FIGS. 1-3, according to an embodiment of the present invention, a manicure practice hand model, comprising a practice hand model 1, wherein the practice hand model 1 comprises a simulated palm and several simulated fingers 12 mounted at a front end of the simulated palm, and simulated fingernails 11 are provided on fingernail beds at free ends of fingertips on a back side of the several simulated fingers 12. Each simulated fingernail 11 comprises an outer fingernail surface 110 and an inner fingernail surface 111, wherein the outer fingernail surface 110 is used for exercises of painting, decoration and creation, and the inner fingernail surface 111 is fixed on the simulated finger 12 by means of the fingernail fixing member 112.

The fingernail fixing member 112 is a “T”-shaped uniform elongated block having a wide upper and lower end face and a narrow middle portion; nail mounting grooves 121 are provided on the fingernail bed of the free end of the fingertip 123 on the back side of each simulated finger 12; an inverted T structure groove 122 in interference fit with the “T”-shaped elongated block of the fingernail fixing member 112 is provided at the bottom of the fingernail mounting groove 121; a mortise and tenon structure is formed by the “T”-shaped elongated block of the fingernail fixing member 112 and the inverted T structure groove 122; the fingernail fixing member 112 of the simulated fingernail 11 is inserted into the fingernail mounting groove 121 from the fingernail mounting groove 121 of the fingertip end 123; and the fixing method can well fix the simulated fingernail 11 on the simulated finger 12, and there will be no loosening phenomenon after multiple extractions and replacements. An open notch at the fingertip end 123 is provided on the inverted T structure groove 122, thereby facilitating insertion and extraction of the fingernail fixing member 112. When the simulated fingernail 11 is mounted, the fingernail fixing member 112 is inserted into the finger fingernail mounting groove 121 from the fingertip end 123, and the “T”-shaped elongated block of the fingernail fixing member 12 has a shape and size matching with those of the inverted T structure grooves 122.

The fingernail fixing member 112 further comprises a fixing attachment member 113, wherein the fixing attachment member 113 is provided at the rear half portion 116 of the fingernail which is in contact with the inner fingernail surface 111, the length of the fixing member attachment body 113 is the same as the length of the fingernail fixing member 112, an attachment surface of the fixing member attachment body 113 has a width greater than the width of an end face of the fingernail fixing member 112 or the width in the groove of the inverted T structure groove 122; and the larger width of the fixing member attachment body 113 can increase the contact area between the fingernail fixing member 112 and the inner fingernail surface 111, thereby facilitating firm bonding.

The inner fingernail surface 111 of the simulated fingernail 11 comprises a fingernail center line 114 taking a direction where the fingernails point as a longitudinal direction the stimulated fingernail 11 is in a left-right symmetrical structure with respect to the fingernail center line 114; an attachment surface of a fixing member attachment body 113 is bonded to the fingernails center line 114; and a middle line of the fixing member attachment body 113 coincides with the fingernail center line 114.

The overall shape of the simulated fingernail 11 is a curved surface in which the outer fingernail surface 110 is curved toward the inner fingernail surface 111. With regard to the curve of the left and right edges of the simulated fingernail 11 retracted toward the front half portion 115 of the simulated fingernail, the front edge of the fingernail front half portion 115 is a straight edge, and the rear edge of the fingernail rear half portion 116 is an arc where the curves on the left and right sides are connected smoothly. The outer fingernail surface 110 of the simulated fingernail 11 curves toward the inner fingernail surface 111 from the fingernail center line 114 to the edges on both the left and right sides, and the transverse cross-section of the simulated fingernail 11 is in a smooth curve shape symmetrical to the left and right. The outer fingernail surface 110 curves toward the fingernail front half portion 115 and the fingernail rear half portion 116 along the fingernail center line 114, respectively. The longitudinal section of the simulated fingernails 11 has a smooth curved shape.

The thickness of the simulated fingernail 11 is adjusted to gradually decrease from the fingernail rear half portion 116 to the fingernail front half portion 115, and the thickness of the fingernail front half portion 115 of the simulated fingernail 11 is less than the thickness of the fingernail rear half portion 116, so that the front end face of the fingernail front half portion 115 can be conveniently finished on the premise of not affecting the fixation of the fingernail rear half portion 116.

From the above description, it can be determined that the above embodiments of the present invention achieve the following technical effects:

1. The present invention simulates the shape of a human hand, having a simulated fingernail capable of being flexibly disassembled, and forms a tenon and mortise structure by matching the “T” shaped fingernail fixing member on the simulated fingernail having the inverted T structure groove on the simulated finger, has the firmly mounting, is suitable for multiple extraction and replacement, has the overall shape of the simulated nail is similar to that of most human fingernails, and is convenient for manicurists to performing simulation training.

2. Compared with the prior art, the simulated fingernail and the training simulation hand of the present invention are separable, can be used multiple times, and the mounting and replacement operations are simple, so that multiple replacement operations can be satisfied without affecting the mounting and the stability use, and the manicure practice hand model of the present invention is more economical and durable for users and manicure trainers.

The above description is only the preferred embodiments of the present invention, and is not intended to limit the present invention. For those skilled in the art, the present invention may have various modifications and variations. Any modification, equivalent replacement, improvement and the like made within the spirit and principles of the present invention shall be included in the protection scope of the invention.

1. A manicure practice hand model, comprising a practice hand model, wherein the practice hand model comprises a simulated palm and several simulated fingers mounted at a front end of the simulated palm, and simulated fingernails are provided on fingernail beds at free ends of fingertips on a back side of the several simulated fingers; nail mounting grooves are provided on the fingernail beds of the free ends of the fingertips on the back side of the simulated fingers; the fingernail mounting grooves are each provided along a fingertip end toward the root of the finger; and each simulated fingernail comprises an outer fingernail surface used for manicure and an inner fingernail surface, the inner fingernail surface is provided with a fingernail fixing member, and the fingernail fixing member has a shape and size matching with those of the fingernail mounting grooves.

2. The manicure practice hand model of claim 1, wherein the fingernail fixing member is an “I”-shaped uniform elongated block having a wide upper and lower end face and a narrow middle portion, and the fingernail mounting groove is an inverted T structure groove having an inverted “T”-shaped cross section.

3. The manicure practice hand model of claim 2, wherein a mortise and tenon structure is formed by the fingernail fixing member and the inverted T structure groove.

4. The manicure practice hand model of claim 2, wherein an open notch at the fingertip end is provided on the inverted T structure groove.

5. The manicure practice hand model of claim 2, wherein the fingernail fixing member further comprises a fixing member attachment body, and an attachment surface of the fixing member attachment body is fixedly bonded to the inner fingernail surface.

6. The manicure practice hand model of claim 5, wherein the attachment surface of the fixing member attachment body has a width greater than a width in a groove of the inverted T structure groove.

7. The manicure practice hand model of claim 5, wherein the inner fingernail surface comprises a fingernail center line taking a direction where the fingernails point as a longitudinal direction, and the simulated fingernail is symmetrical with respect to the fingernail center line.

8. The manicure practice hand model of claim 6, wherein when the fixing member attachment body is bonded to the inner fingernail surface, the longitudinal center line of the fixing member attachment body coincides with the fingernail center line of the inner fingernail surface.

9. The manicure practice hand model of claim 5, wherein each simulated fingernail comprises a fingernail rear half portion mounted on the simulated finger and a fingernail front half portion extending out of the fingertip end, and the fixing member attachment body is bonded to the fingernail rear half portion of the inner fingernail surface.

10. The manicure practice hand model of claim 7, wherein the overall shape of each simulated fingernail is a curved surface in which the outer fingernail surface is curved toward the inner fingernail surface.
